(19) United States
(12) Patent Application Publication
(10) Pub. No.: US 2025/0006391 A1
(43) Pub. Date: Jan. 2, 2025

(54) COMPUTER IMPLEMENTED METHOD FOR SIMULATING AN OPERATION OF A REACTOR CORE

(71) Applicant: FRAMATOME, COURBEVOIE (FR)

(72) Inventor: René VAN GEEMERT, ERLANGEN (DE)

(21) Appl. No.: 18/705,363

(22) PCT Filed: Oct. 25, 2022
(86) PCT No.: PCT/EP2022/079792

§ 371 Date: Apr. 26, 2024

(30) Foreign Application Priority Data
Oct. 27, 2021 (EP) 21306504.8

(51) Int. Cl. G21D 3/00; G21D 3/10

(52) U.S. Cl. CPC G21D 3/002; G21D 3/10

(57) ABSTRACT

A computer implemented method for simulating an operation of a reactor core includes determining an initial state of the reactor core; calculating a nodal target power distribution and/or the target 3D neutron flux distribution; obtaining an actual power distribution and/or the actual 3D neutron flux distribution of the nuclear reactor core; determining a difference between the target power distribution and the actual power distribution of the nuclear reactor core and/or determining a difference between the target 3D neutron flux distribution and the actual 3D neutron flux distribution of the nuclear reactor core; determining modal expansion coefficients using a Fourier modal decomposition based on the determined difference and applying a Modal Generalized Perturbation Theory to the modal expansion coefficients for determining a 3D cross-section distribution perturbation causing the determined difference; and determining a 3D adaptation distribution for the determined difference based on the determined 3D cross-section distribution perturbation.

### CROSS-REFERENCE TO RELATED APPLICATIONS

This application is the U.S. National Phase of PCT Appl. No. PCT/EP2022/079792 filed Oct. 25, 2022, which claims priority to EP EP21306504.8, filed Oct. 27, 2021, the entire disclosures of which are incorporated by reference herein.

### TECHNICAL FIELD

The present disclosure concerns a computer implemented method for simulating an operation of a reactor core.

### BACKGROUND

Typically, a basic property of many reactor core models follows a necessary trade-off between enabled overall accuracy versus computational efficiency. This applies especially to nodal reactor codes, which must enable detailed computations for 3D full-core reactor cycles, core transients etc. with modest/practical time CPU run time requirements. This is fulfilled through use of smart modeling approaches. An example is the use of the so-called Nodal Expansion Method, that enables the computation of a reactor core's 3D power distribution with sufficient computational efficiency for allowing daily large-scale extensive reactor cycle burnup and transient computations. However, such approaches come at the price of giving up the highest feasible standards in overall system modeling sophistication. This price must be paid nonetheless, due to the practical reason that application of those highest feasible (i.e. high-fidelity) modeling standards would give rise to absolutely prohibitive computational run times: each computation would last far too long for still enabling the above-mentioned daily large-scale extensive reactor cycle burnup and transient computations. Whereas a core designer or a transient safety analyst must see his/her computation concluded, with results delivered, after typically half an hour at most, high-fidelity computations may last days up to even weeks. This is why (even today) lower-fidelity (yet sufficiently accurate) models are used, such that short run times are enabled.

Further, even when a perfect high-fidelity model would be used, due to uncertainties in system property information, such as nuclear data, material densities, geometry specifications etc., there will always be some deviation between model and reality. Obviously also, the reality cannot be probed or measured without certain limitations for that, and any kind or process for probing and measuring will feature some inherent uncertainties as well.

As an example, sometimes the application of some fixed heuristic adaptation approach, with which the computed 3D power distribution can be tuned in a radial center-to-periphery manner, is a fixed ingredient of the reactor code computations as performed for a specific reactor core.

Such heuristic approaches do typically feature clear restrictions in degrees of freedom for decreasing the overall 3D discrepancy between the 3D results of the model and the 3D observations. Due to these restrictions, the achieved 3D agreement is always limited in quality, and always inferior compared to what a postulated ideal approach would enable. Additionally, not rarely such heuristic adaptation approaches actually impose changes in the model that cannot possibly be commensurate with the ideal 3D model correction distribution (that can be postulated to exist). As such, heuristic adaptation approaches are non-ideal from several different perspectives.

In these same contexts, there is usually also a high interest in acquiring knowledge about the true 3D discrepancy root cause distribution, which may be local errors. These local errors can be due to locally reduced validity of applied model approximations (such as the diffusion approximation).

The Article “MODAL ANALYSIS OF 3D FULL-CORE INHOMOGENEOUS ADJOINT NODAL EQUATIONS AND ASSOCIATED ITERATIVE SOLUTION PROCESSES”, Proceedings M&C 2019, Portland OR, USA (2019), of R. van Geemert relates to the modal analysis of a nuclear core. In particular, this disclosure describes the Modal Generalized Perturbation Theory (MGPT). It further discloses the use of a multi-modal deflation technique for the efficient computation of higher modal solutions of a reactor core state.

EP 2 287 853 B1 discloses a computer implemented method for modelling a nuclear reactor core. The method includes partitioning the core in cubes to constitute nodes of a grid for computer implemented calculation. Then, a neutron flux is calculated by using an iterative solving procedure of at least one eigensystem corresponding to a steady-state diffusion equation, the components of an iterand of the eigensystem corresponding either to a neutron flux, to a neutron outcurrent or to a neutron incurrent, for a respective cube to be calculated, the neutron outcurrent coming from a respective cube and the neutron incurrent coming into a respective cube.

CN101399091 relates to nuclear reactor core power monitoring field and discloses a method for online monitoring of the neutron flux distribution of the reactor core. The method is based on the use of measurement data supplied by M1 internal neutron detectors and external neutron detectors which are arranged on the reactor. According to a reference reactor core model, as expressed by the eigenvalue state equation Mϕ=(1/k) Fϕ, higher order harmonics are solved. The higher-order harmonic waves are used to (re-)construct the actual 3D neutron flux distribution in the reactor core.

### SUMMARY

One aim of the present disclosure is to enable power shape sensitivity analyses, and also inversion actions that enable goal-oriented adaptation and improvement of the reactor core model, in particular to by an enabled determination of a most plausible 3D root cause spatial distribution that is consistent with a 3D discrepancy distribution observed between a model and the actual (i.e. measured) power distribution and/or the actual 3D flux of neutrons of the nuclear reactor core.

According to one aspect, a computer implemented method for simulating an operation of a reactor core, the method comprising:
determining an initial state of the reactor core, the reactor core comprising a plurality of fuel assemblies, wherein the core is partitioned in cubes to constitute nodes of a grid;
calculating, based on the initial state, a nodal target power distribution and/or the target 3D neutron flux distribution;
obtaining an actual power distribution and/or the actual 3D neutron flux distribution of the nuclear reactor core;
determining a difference between the target power distribution and the actual power distribution of the nuclear reactor core and/or determining a difference between the target 3D neutron flux distribution and the actual 3D neutron flux distribution of the nuclear reactor core; determining modal expansion coefficients using a Fourier modal decomposition based on the determined difference and applying a Modal Generalized Perturbation Theory, MGPT, to the modal expansion coefficients for determining a 3D cross-section distribution perturbation causing the determined difference; and
determining a 3D adaptation distribution for the determined difference based on the determined 3D cross-section distribution perturbation.

Further embodiments may relate to one or more of the following features, which may be combined in any technical feasible combination:
the initial state of the reactor core includes as parameters the core grid, the core size, the nuclide densities, the material densities, the nuclear fuel loading structure and/or the nodal cross-sections;
constraints for a 3D cross-section perturbation distribution are defined in order to determine the 3D adaptation distribution for the perturbation;
the constraints are selected from a group comprising: constraining the 3D cross-section distribution perturbation only in variations in fast diffusion coefficients wished for, in particular for the reflector nodes; constraining only variation in water density wished for; and/or constraining variations in a certain nodal transport cross-section type, in particular fission or absorption;
the target power distribution and/or the target 3D neutron flux distribution is determined using a Nodal Expansion Method;
For calculating the target power distribution and/or the target 3D neutron flux distribution the following equation is solved:

$$\hat{M} [ {c}_{B} , ϕ ] ϕ = \frac{1}{{k}_{eff}} \hat{F} ϕ ,$$

wherein \hat{M} represents the combined operator for neutron absorption, leakage and scattering, \hat{F} represents neutron production through fission, ϕ represents the 3D neutron flux distribution, c_{B} represents the concentration of solution boron in the reactor core, and k_{eff} represents the effective multiplication factor of the reactor core.
the actual power distribution and/or the actual 3D neutron flux distribution of the nuclear reactor core is obtained through measurements and/or a reference computation;
determining a 3D cross-section distribution perturbation causing the determined difference includes reducing the number of expansion coefficients;
determining a 3D cross-section distribution perturbation causing the determined difference includes using a fitting approach by using determining the minimum of the difference between expansion coefficients calculated by applying a Modal Generalized Perturbation Theory and the modal expansion coefficients determined using by using the Fourier modal decomposition; and/or
The method further includes adapting the parameters of the initial state of the reactor core, based on the 3D adaptation distribution, wherein, in particular, the parameters include the core grid, the core size, the nuclide densities, the material densities and/or the nuclear fuel loading structure and/or nodal cross-sections; and
   recalculating, based on the adapted initial state, for each node a target power distribution and/or the target 3D neutron flux distribution.

According to another aspect, a computer implemented method for optimizing a reactor core provided, wherein the reactor core is simulated according to a method disclosed herein, wherein the method further includes the following step:
permuting fuel assemblies based on the 3D adaptation distribution, optimizing the core loading pattern based on the 3D adaptation distribution and/or optimizing the fuel assembly design based on the 3D adaptation distribution.

According to another aspect, a computer program product comprising instructions, which, when the program is executed by a computer, cause the computer to carry out the computer implemented method of one of the embodiments disclosed herein.

According to another aspect, a data carrier signal is provided carrying the computer program product of an embodiment disclosed herein.

According to another aspect, a computer-readable storage medium comprising instructions which, when executed by a computer, cause the computer to carry out the computer implemented method of one of the embodiments disclosed herein.

According to another aspect, a data processing system comprising means for carrying out the computer implemented method of one of the embodiments disclosed herein.

According to a further aspect, a computer program product is provided comprising commands for executing the method according an embodiment disclosed herein, when loaded and executed on a processor. According to an embodiment, a computer program product may be a physical software product, for example a hard disc, a solid state disc, a CD-ROM, a DVD, comprising the program.

Embodiments are also directed to the system for carrying out the disclosed methods steps and in particular including apparatus parts and/or devices for performing described method steps.

The method steps may be performed by way of hardware components, firmware, software, a computer programmed by appropriate software, by any combination thereof or in any other manner.

According to another aspect, a data carrier signal carrying the computer program product according to an embodiment disclosed herein is provided.

According to other aspects, the present disclosure relates to computer-readable non-volatile storage medium, for example a hard disc, a solid state device, a CD-ROM, a DVD, storing a program containing commands for executing the method according an embodiment disclosed herein, when loaded and executed on a processor.

Further advantages, features, aspects and details are evident from the dependent claims, the description and the drawings.

### BRIEF SUMMARY OF THE DRAWINGS

The accompanying drawings relate to embodiments of the present disclosure and are described in the following:

FIG. 1 shows schematically a nuclear reactor;

FIG. 2 shows a flow chart of an embodiment of the present disclosure.

FIG. 3 a section of a core of the basic modal shape with an “east west” azimuthal orientation, wherein for each node the modal neutron flux value is shown of the highest energy group.

FIG. 4 a section of a core of the basic mode with an “North south” orientation;

FIG. 5 10^{th} mode, wherein for each node the modal neutron flux value is shown of the highest energy group;

FIG. 6 48^{th} mode, wherein for each node the modal neutron flux value is shown of the highest energy group;

FIG. 7 shows an example of a given known 3D cross-section distribution perturbation (or uncertainty) δΣ;

FIG. 8 illustrates the agreement between the expansion coefficients, predicted via MGPT versus the same coefficients calculated by Fourier filtering of the difference between the exact perturbed 3D target 3D neutron flux distribution and the exact unperturbed target 3D neutron flux distribution;

FIG. 9 shows an exact change in 3D neutron flux distribution δϕ (as obtained through complete repetition of the full iterative solution process applied to the perturbed core state);

FIG. 10 shows a MGPT-predicted change in the 3D neutron flux distribution δϕ (as obtained through application of the MGPT-computed expansion coefficients and associated weighted summation of the available higher modal solution expansion components);

FIG. 11 illustrates a typical lower-diagonal structure of the matrix B;

FIG. 12 shows a calculation using a heuristic model; and

FIG. 13 shows a calculation using the method according to the present disclosure.

### DETAILED DESCRIPTION

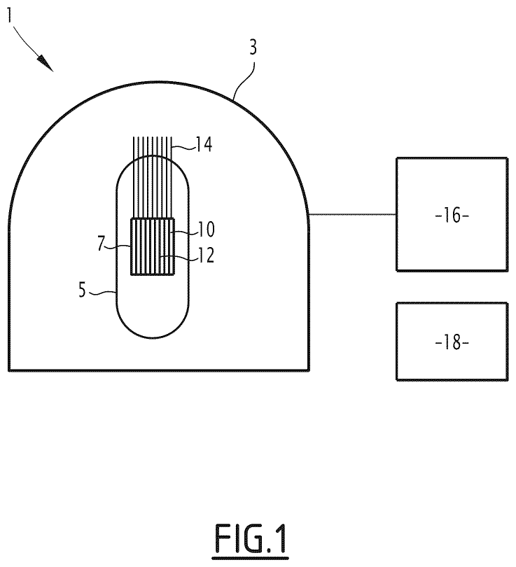

FIG. 1 shows schematically a nuclear reactor 1. The nuclear reactor includes a containment 3 and a reactor pressure vessel 5. Within the reactor pressure vessel 5, the reactor core 7 is arranged. The reactor core 7 includes a plurality of fuel assemblies 10. Each fuel assembly 10 includes a plurality of fuel rods 12 comprising pellets of nuclear fuel. The reactor core 7 is controlled using control rods 14 for controlling the chain reaction of the nuclear reactor 1. Further, a plurality of sensors are provided (not shown) that are adapted to measure different parameters of the reactor core 7 during operation. The measurement results are provided to an instrumentation and control computing devices 16. The instrumentation and control computing devices 16 may be arranged in a control room. Further, there is provided a processor 18, which is adapted to simulate the reactor core 7, in particular by using the measurement results. Also, other input may be provided to the processor 18, which are necessary to simulate the reactor core 7.

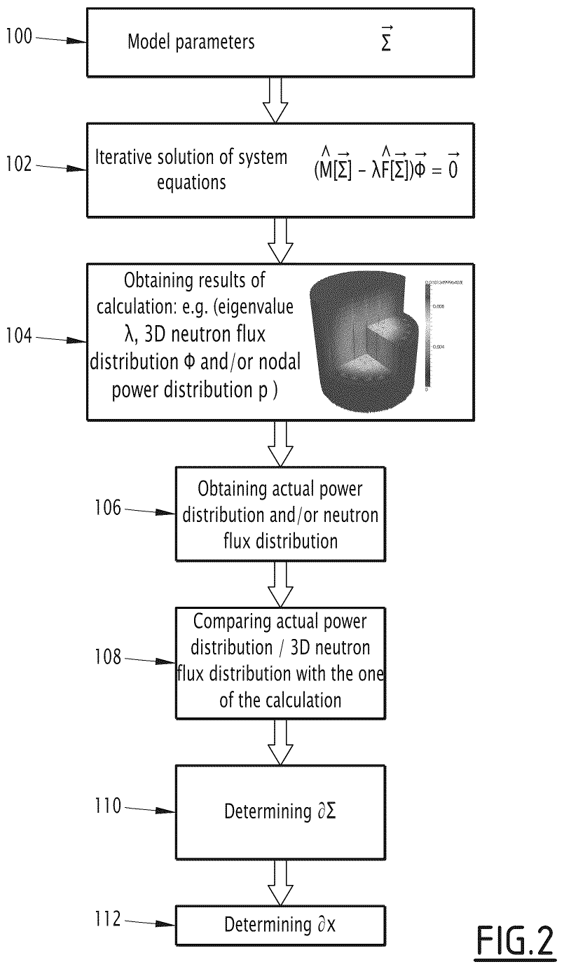

FIG. 2 shows a flow chart of a method of an embodiment of the present disclosure. For example, the method may be performed by the processor 18 of the nuclear reactor 1 or of a nuclear power plant comprising the nuclear reactor 1.

In a first step, step 100, an initial state of the reactor core 7 is determined. For example, initial parameters are obtained using the initial state of a reactor core 7. The reactor core 7 is partitioned into cubes, which constitute nodes of a grid. For example, the initial state of the reactor core 7 includes the parameters the reactor core grid, the reactor core size, the nuclide densities, the material densities the nuclear fuel loading structure and/or the nodal cross sections, which is or are, for example, provided to the processor 18. In other words, each node being a volume element of the reactor core 7 and in particular a surrounding reflector. The reactor core 7 being built as total volume by a few (dozens of) thousands volume elements i.e. nodes.

In a next step 102 the nodal target power distribution p and/or the target 3D neutron flux distribution CD is calculated based on the initial state. For example, for that purpose, an iterative process, which solves system equations, as shown here below under (1) or (2) is executed, for example by the processor 18. In an embodiment, a Nodal Expansion Method method is used for that purpose. For example, such a process is disclosed in H. Finnemann, F. Bennewitz, M. Wagner, Interface current techniques for multidimensional reactor calculations, Atomkernenergie (ATKE) 30 (1977), referred to as [Finnemann 1977], Y. I. Kim, Y. J. Kim, S. J. Kim, T. K. Kim, A semi-analytic multi-group nodal method, Annals of Nuclear Energy 26, pp. 699-708 (1999), referred to as [Kim 1999] and/or R. van Geemert, Multi-Level Criticality Computations in AREVA NP's Core Simulation Code ARTEMIS, Proceedings of PHYSOR 2010, Pittsburgh, USA (2010), referred to as [Van Geemert 2010], wherein the iterative processes disclosed in [Finnemann 1977], [Kim 1999] and [Van Geemert 2010] are incorporated by reference.

Based on the model parameters, a target 3D nodal power distribution p and/or a target 3D neutron flux distribution ϕ is calculated using the above iterative process for each node and each energy group. Typically, this is calculated with two energy groups. As part of the solution process, the core's neutronic λ-eigenvalue (which is the inverse of the core's effective multiplication factor) is determined iteratively (step 104). In some embodiments, this is shaped as a so-called critical boron concentration search, which finds the specific boron concentration (that influences the thermal macroscopic absorption cross-sections in all nodes directly) that enables a λ-eigenvalue that is precisely equal to 1. Such calculations can be found for example in J. J. Duderstadt, L. J. Hamilton, Nuclear Reactor Analysis, Wiley & Sons (1975) (herein referred to as [Duderstadt 1975]), or R. van Geemert, Analysis of Sensitivity and Uncertainty Propagation for Industrial Reactor Simulation Tools, Lecture Notes provided for the Frédéric Joliot & Otto Hahn (FJOH) Summer School in Nuclear Reactor Physics, KIT/CEA, Karlsruhe KIT Campus, (August 2017) (hereafter referred to as [Van Geemert 2017]). The calculations disclosed in [Duderstadt 1975] and [Van Geemert 2017] are incorporated herein by reference.

As it is known, as a result of occurred atom fissions (induced by a fissionable atom such as uranium or plutonium having captured a neutron), two smaller atoms (=fission products) emerge, plus 2 or 3 (average about 2.5) neutrons, all with high kinetic energy. This emerged kinetic energy is made available by the property of the added masses of the emerged products being lower than the original mass of the fissionable atom. If Δm is the mass difference, then the total kinetic energy released due to the fission reaction is ΔE=(Δm) c2, with c2 the square of the c which is the speed of light. Following this fission reaction, the emerged neutrons have a very high kinetic energy, hence a very high speed with which they start migrating through the reactor. However, immediately they get moderated (slowed down) by interactions (i.e. collisions) with water molecules, hence their speed gets reduced, they lose kinetic energy until they are far slower. It is the slow neutrons (in the so-called thermal energy range) that again can be captured by fissionable atoms, triggering new fissions with new (high-speed) neutrons emerging etc. If a sufficient number of fissionable atoms are present as compared to the presence of neutron moderators (water) and neutron absorbers (boron, cadmium in the control materials) then a controllable self-sustaining overall neutron chain reaction can be established. For modelling all this in appropriate equations, the so-called neutron transport/diffusion equations must accommodate different (kinetic) energy levels for the traveling neutrons. However, the energy spectrum is actually continuous, however in computationally efficient models a so-called lumping is done, putting the neutrons in energy bands that together do cover the entire relevant neutron (kinetic) energy spectrum. In full-fledged neutron transport solvers, there can still be dozens of such value bands (often denoted as energy groups), which are typically indexed from 1 to NG (with NG denoting the Number of Groups). Hence, in such models, the solved neutron flux distribution is given in terms of not only its spatial distribution but also its (kinetic) energy distribution by the given (energy) group values per spatial location. In nodal diffusion models (which are coarse but computationally highly efficient variants of the neutron transport equation), which are used in embodiments disclosed herein to determine the target 3D nodal power distribution p and/or the target 3D neutron flux distribution ϕ it is typically sufficient to work with two lumped energy groups only: high energy and low energy.

Some embodiments additionally include a heuristic adaptation approach that enables a heuristic correction of the computational model, for achieving an overall better agreement with measured 3D power shapes.

As explained above and also disclosed in van Geemert FJOH Lecture Notes of August 2017, mentioned above as [Van Geemert 2017], nodal reactor simulators include the application of iterative solution methods, which are used to solve the different relevant systems of equations. Such nodal reactor simulators are commercially available and they have been applied since many years now, with examples being ARTEMIS™ (which is part of Framatome's ARCADIA reactor computation tool suite) and PRISM (which is part of Framatome's CASCADE-3D reactor computation tool suite, whose original development dates back to the 1980s and 1990s, of Siemens/KWU. Other examples of reactor codes with extensive industrial application record are NEMO (developed at Framatome Inc in the USA) and SCIENCE (developed by Framatome SAS in France). Details of these systems have been for example published in the following articles R. G. Grummer et al., Siemens Integrated Code System CASCADE-3D for Core Design and Safety Analysis, Proceedings PHYSOR 2000, Pittsburgh, USA (2000) (hereafter referred to as [Grummer 2000]), Pautz et al, The ARTEMIS Core Simulator: a Central Component in AREVA NP's Code Convergence Project, Proceedings M&C+SNA 2007, Monterey, USA (2007) [hereafter referred to as [Pautz 2007]], and G. Hobson et al., ARTEMIS: The core simulator of AREVA NP's next generation coupled neutronics-thermalhydraulics code system ARCADIA, Proceedings PHYSOR 2008, Interlaken, Switzerland (2008) [hereafter referred to as [Hobson 2008]. The calculations disclosed in [Grummer 2000], [Hobson 2008] and [Pautz 2007] are incorporated herein by reference.

In embodiments, such algorithms may be implemented in step 102.

The core's neutronic λ-eigenvalue is the fundamental eigenvalue associated with the fundamental mode solution of the modelled 3D nodal diffusion equation. The term “fundamental eigenvalue” comes the nomenclature as documented in the reference literature on neutron transport modal solutions, which are all solutions of the same eigenvalue equation system, with different eigenvalues and hence different solutions associated with these different eigenvalues. The highest (or lowest, depending on the specific eigenvalue definition) is the one associated with specific modal solution that, in dynamic behavior, is the one typically emerging as the dominant one. If the eigenvalue has the physical meaning of the core's so-called effective multiplication factor, the it is the highest eigenvalue (and its associated 3D solution) that is referred to as fundamental eigenvalue, with its associated 3D solution being the fundamental mode. It is this fundamental mode that will emerge as the result of a neutron transport/diffusion solution process for a stationary reactor state.

The neutronic λ-eigenvalue applies to the stationary, self-sustaining flux/current solution of the core of the nuclear reactor as a whole, see for example [Duderstadt 1975, Van Geemert 2017] Such an equation, such as established by H. Finnemann, F. Bennewitz, M. Wagner, “Interface current techniques for multidimensional reactor calculations”, Atomkernenergie (ATKE) 30, 1977 [Finnemann 1977], is shown here below:

$$\hat{M} [ {c}_{B} ] ϕ = \frac{1}{{k}_{eff}} \hat{F} ϕ , \qquad ( 1 )$$

wherein)
\hat{M} represents the combined operator for neutron absorption, leakage and scattering, wherein each element corresponds to individual nodes and energy groups, and associated neighbor and/or energy group coupling;
\hat{F} represents neutron production through fission, wherein each element corresponds to individual nodes and energy groups, and associated neighbor and/or energy group coupling;
ϕ represents the 3D neutron flux distribution, which is a vector in terms of the nodal and energy-group values. This is a symbolic notation, since the actual solution vector (the solution ϕ of equation (1)) consists of the so-called interface currents, defined per node, energy group, Cartesian direction (x,y,z) and orientation (left, right),
c_{B} represents the concentration of solution boron in the reactor core, and
k_{eff} represents the effective multiplication factor of the reactor core.

The soluble boron concentration c_{B} is obviously constrained through the requirement that its value should enable exact criticality: c_{B}:k_{eff}[c_{B},ϕ[c_{B}]]=1.

With respect to the operator M explained here-above, the term energy group coupling is further explained in this paragraph. Through the dynamic interplay between the different energy groups in the neutron transport equation, there is a numerical coupling between them. The high-energy neutrons get moderated (slowed down), until they are slow enough to get captured by a fissionable atom, causing a fission from which 2 or 3 new (high speed/energy) neutrons emerge. Hence, the high energy component of the solution is coupled with the low energy component of the solution, through the associated process cross-sections (for downscattering from the high energy group to the low energy group by moderation of neutrons in water, for absorption of neutrons (in boron, cadmium/control rods, structural material) and for absorption-followed-by-fission (fissionable atoms). Actually the neutron transport/diffusion equation consists of NG coupled equations, each representing the specific energy group g (with g=1, . . . , NG) and with each equation including terms that are influenced by neutron flux values as pertaining to either higher or lower energy groups. In a 2-group model, this boils down simply to the causal/numerical coupling between the high (fast) energy group and the low (slow/thermal) energy group.

Due to the multi-physics nature of both the real life reactor and the model thereof, and due to feedback mechanisms arising because of that, especially the operator \hat{M} depends partially on the solution of the 3D neutron flux distribution ϕ. Hence, in real life and in a multi-physics reactor code, the governing sets of coupled equations can be denoted compactly and symbolically by:

$$\hat{M} [ {c}_{B} , ϕ ] ϕ = \frac{1}{{k}_{eff}} \hat{F} ϕ \qquad ( 2 )$$

Generally, the influence of the small perturbation will propagate itself over a self-sustaining standing 3D wave of the core-wide neutron flux distribution, as slight change in the global solution of the balanced interplay between neutron absorption, fission, scattering and leakage. Hence, the effect of the small perturbation will repeatedly travel from its location of origin over the core-wide self-sustaining 3D system solution, all the way towards the system boundary and back, until a new stationary equilibrium is finally established.

From a mathematical physics point of view, equilibrium changes in self-sustaining systems will always manifest themselves in terms of triggered introductions of higher modal components of the unperturbed state.

Similar to the continuum formulation for the continuous space-energy diffusion equation formulation, see J. J. Duderstadt, L. J. Hamilton, Nuclear Reactor Analysis, Wiley & Sons (1975) [Duderstadt 1975], the nodal diffusion equations also have valid higher modal eigenvalues k_{f} (with k₀≥k₁≥k₂≥ . . . ), associated with higher modal 3D neutron flux distribution solutions ϕ [symbol] :

$$\hat{M} [ {c}_{B} ] {ϕ}_{ℓ} = \frac{1}{{k}_{ℓ}} \hat{F} {ϕ}_{ℓ} \qquad ( 3 )$$

Further, also the notation λ [symbol] =1/ [symbol] for the lambda-eigenvalues λ [symbol] is used:

$$\hat{M} [ {c}_{B} ] {ϕ}_{ℓ} = {λ}_{ℓ} \hat{F} {ϕ}_{ℓ} \qquad ( 4 )$$

The index [symbol] reflects the successive eigenvalue-wise ranking of the modal 3D neutron flux distribution solution [symbol] for the respective variables. λ₀ is the fundamental eigenvalue associated with the fundamental mode solution [symbol] (with [symbol] =0), and the λ [symbol] are the higher modal eigenvalues associated with the higher modal solutions [symbol] . In other words, the 3D neutron flux distribution has a normal or fundamental mode at [symbol] =0 and higher modes with [symbol] >0.

There exist also an adjoint nodal diffusion eigenvalue equation. The adjoint operators induce a reversal of flow direction and of spectral operations. In terms of matrix properties, adjoint matrices follow from transposing the forward matrices.

$${\hat{M}}^{†} [ {c}_{B} ] {ϕ}_{ℓ}^{†} = {λ}_{ℓ} {\hat{F}}^{†} {ϕ}_{ℓ}^{†} \qquad ( 4 a )$$

A transposed matrix is marked with “↑”. Beyond the fundamental solution λ₀, λ₀^{↑}, these obviously also have higher modal solutions λ [symbol] , [symbol] ^{†}, [symbol] =1, 2, 3, . . . , with λ₀≤λ₁≤λ₂≤ . . . . In development and implementation reality, the adjoint operators may include cascades of different operators applied successively, such as A B C, with the adjoint (A B C)^{↑} following from the commutativity rule (A B C)^{↑}=C^{↑}B^{↑}A^{↑}, with usually the individual adjoint operators following from transposing their matrix representations. From a mathematical physics point of view, it is essential to be aware of the following conjugacy property between adjoint and forward modes:

$$〈 {ϕ}_{ℓ}^{†} \vert \hat{F} {ϕ}_{k} 〉 = {t}_{ℓ} {δ}_{ℓ k} = \{ \begin{matrix}{t}_{ℓ} & if ℓ = k \\ 0 & otherwise\end{matrix} \qquad ( 4 b )$$

wherein t [symbol] = [symbol] ^{↑}|F [symbol] >] and [symbol] is an index for successive ranking of the modes and their eigenvalues. This implies the important property that the adjoint and forward modes enable close-to-orthonormal expansions for 3D neutron flux change distributions δϕ. The latter can be treated as weighted sums of higher modes, with the expansion weights depending on the relevant perturbation sources and their spatial locations in the core. As such, the adjoint modes enable the computation of expansion coefficients for forward fundamental mode perturbations in terms of higher forward unperturbed modes, and vice versa. Specifically, the change in 3D neutron flux distribution δϕ in a self-sustaining system (with usually λ₀=1), due to some local perturbation (true change or assumed uncertainty), or due to some distribution of perturbations δ\hat{M} and/or δ\hat{F} Generally, a perturbation (with influence on the 3D cross-section distribution Σ, including for example the nodal cross-section of absorption or fission Σ_{f} and/or Σₐ, can be imposed anywhere in the nuclear core 7, whether only in one point/location, in a number of different points/locations, or basically everywhere (such as when perturbing the boron concentration in the nuclear core 7), therefore usually it has to be dealt with a certain spatial distribution of perturbations; the local non-zero values for the perturbation of the 3D cross-sections distribution δΣ lead to perturbations δ\hat{M} and δ\hat{F} in the operators \hat{M} and \hat{F}, associated with the same perturbation positions in the nuclear core 7), can be regarded as a weighted sum over higher modes ( [symbol] =1 to infinity), see also Gandini, Implicit and Explicit Higher Order Perturbation Methods for Nuclear Reactor Analysis, Nuclear Science and Engineering 67, 347 (1987):

$$δϕ = {\sum }_{ℓ = 1}^{∞} \frac{1}{{t}_{ℓ} ( {λ}_{ℓ} - {λ}_{0} )} 〈 {ϕ}_{ℓ}^{†} \vert ( {λ}_{0} δ \hat{F} - δ \hat{M} ) {ϕ}_{0} 〉 {ϕ}_{ℓ} \qquad ( 4 c )$$

The [symbol] th mode [symbol] is excited if the distribution of local operator perturbations (i.e. uncertainties or model imperfections as represented by δ\hat{F} (perturbation of neutron production through fission) and δ\hat{M} (perturbation of neutron absorption, leakage and scattering)) more or less coincides with the spatial shape of the [symbol] th adjoint mode [symbol] (and thereby also with the spatial shape of the [symbol] th forward mode [symbol] ). Due to the division by λ [symbol] −λ₀, magnitudes of excited modes of the 3D neutron flux distribution [symbol] ten to e larger if the associated eigenvalues λ [symbol] are closer to λ₀. The term δϕ represents the difference or change in the 3D neutron flux distribution.

The formula (4) can be also represented in the following way:

$$( \hat{M} [ \vec{Σ} ] - λ \hat{F} [ \vec{Σ} ] ) \vec{ϕ} = \vec{0} . \qquad ( 5 )$$

The 3D neutron flux distribution ϕ can be also described as vector. The 3D multi-group neutron flux distribution ϕ is captured in completeness by the entire collection of solution values per node and per energy group. This adds up to such values for a few (dozens of) thousands of nodes, and sub-arranged per individual node in terms of the different values for each energy group. This entire collection of values can be represented as a vector with length NT×NG, with NT the number of nodes and NG the number of (energy) groups. The vector \hat{Σ} represents the combined, general 3D cross-section distributions, for example of absorption, scattering, transport, fission, etc. In other words the 3D cross-section distributions \vec{Σ} are used that could be adapted for the desired adaptation purposes. A represents the core's neutronic eigenvalue as already introduced here-above. The 3D cross-section distribution \vec{Σ} depends on the 3D power distribution \vec{p}=VκΣ_{f}\vec{ϕ}, where V is the nodal volume vector, K is amount of energy released per fission, and Σ_{f}\hat{ϕ} is the fission rate density. In other words, the fission rate density is the 3D fission cross-section distribution, which is multiplied with the 3D neutron flux distribution. It is mainly the thermal part of the fission cross-section that, combined with the thermal part of the flux, determines the fission rate. There is always still a bit of fast fission as well, however this is less compared to the thermal fission (and this also depends on the neutron energy level chosen to mark the separation between the fast group and the thermal group in a 2-group diffusion model. The power distribution p is a vector of nodal values attached to each node.

At a next step 106 an actual power distribution and/or the actual 3D neutron flux distribution of the nuclear reactor core is obtained. For example, this may be done through measurements and/or reference computations using high fidelity algorithms. High fidelity algorithms may be based on 3D Monte Carlo (which today is still computationally expensive/slow, and having high dynamic memory requirements, hence also requiring expensive hardware) or on detailed 3D computations on very fine space-energy meshes, using highly advanced many-group transport methods (with the latter also requiring very long CPU run times, and very expensive memory and hardware requirements

In step 108, the actual power distribution or actual 3D neutron flux distribution is then compared with the calculated target power distribution or the 3D neutron flux distribution ϕ, respectively. For example, a difference between the target power distribution and the actual power distribution p of the nuclear reactor core and/or a difference δϕ between the target 3D neutron flux distribution ϕ and the actual 3D neutron flux distribution of the nuclear reactor core is determined.

A reactor core's power imbalance sensitivity is actually not necessarily defined specifically in terms of the core's response to specific variations in specific locations, such as imposed in peripheral assemblies; instead it is valid generally with regard to any variation, and the sensitivity is just substantially co-determined by how the 3D distribution of imposed variations pre-adheres to a given modal 3D shape which then it will tend to trigger. Generally, 3D global power shape effects are excited through perturbation influence propagation only if the 3D cross-section distribution perturbation δΣ is such that at least one of the renormalized modal excitation integrals, as defined by the t [symbol] ⁻¹ [symbol] j [symbol] ^{↑}|(δϕ/δΣ) [symbol] in a MGPT (Model Generalized Perturbation Theory) modal expansion coefficient δc [symbol] :

$$δ {c}_{ℓ}^{( MGPT )} [ δ \underline{Σ} ] = \frac{1}{{t}_{ℓ} ( {λ}_{0} - {λ}_{ℓ} )} ( \text{?} \vert ( \partial ϕ / \partial \underline{Σ} ) δ \underline{Σ} ) \qquad ( 5 a )$$

$$\text{?} \text{indicates text missing or illegible when filed}$$

is clearly different from zero. Depending on the value of the modal excitation propagation factor

$$\frac{1}{{t}_{ℓ} ( {λ}_{0} - {λ}_{ℓ} )}$$

for the given mode with index f, in case of a clearly non-zero value for t [symbol] ⁻¹ [symbol] (j [symbol] ^{↑}(δϕ/δΣ)δΣ [symbol] the [symbol] th mode is excited such that it is represented with the modal expansion coefficient δc [symbol] ^{(MGPT)}[δΣ] as given by Eq.(5a). The MGPT formula has been adapted to the change of the 3D neutron flux distribution δϕ instead of interface current relationships j, with the solution vector being the interface current j instead of 3D neutron flux distribution ϕ, with the 3D neutron flux distribution ϕ being a by-product that can be computed iteratively based on known interface current j. According to the present disclosure, MGPT predictions are equated with the Fourier expansion coefficients δc [symbol] for a target change 3D neutron flux distribution δϕ. From that a physically most meaningful 3D root cause 3D cross-section distribution perturbation by that can be assumed to be plausibly responsible for an observed 3D discrepancy between model and the (measured) reality, or for determining a suitable, minimum-necessary adaptation distribution δx for enabling a match with a target 3D power shape, which will be explained later.

The MGPT (Model Generalized Perturbation Theory) methodology is generally used to calculate a change (or uncertainty) δϕ in 3D neutron flux distribution as a function of a 3D cross-section distribution perturbation (or uncertainty) δΣ by in terms of the higher modal eigenvalues [symbol] , the higher modal adjoint solutions [symbol] and the higher modal forward solutions φ [symbol] in terms of non-iterative modal expansion formulas, such as:

$$\begin{matrix}δϕ [ δΣ ] = …… + {\sum }_{ℓ = 1}^{L} \frac{1}{{t}_{ℓ} ( {λ}_{ℓ} - {λ}_{0} )} 〈 {ϕ}_{ℓ}^{†} \vert δ z [ δ Σ ] 〉 {ϕ}_{ℓ} \\ = …… + {\sum }_{ℓ = 1}^{L} δ {c}_{ℓ} {ϕ}_{ℓ}\end{matrix} \qquad ( 6 )$$

The first line represents the sum of triggered global modal effects. An adjoint matrix corresponds to a transposed conjugated matrix and is marked with “⁺” and a transposed matrix is marked with “↑”. The “ . . . ” symbolize some so-called high-frequency terms that are of lesser importance for the global 3D effect, and of lesser importance due to those having no influence on the values of the modal expansion coefficients [symbol] . The [symbol] are given by [symbol] =< [symbol] [symbol] |F [symbol] > and the δz[Σ] are given by δz [Σ]=(δM [δΣ]−λ δF [δΣ]) ϕ₀, with the operator perturbations δM [δΣ] and δF [δΣ] as induced by the 3D distribution of cross-section perturbations δΣ.

To simplify the above term an expansion coefficients [symbol] can be written according to the MGPT formula as follows:

$$δ {c}_{ℓ} [ δ Σ ] = \frac{〈 {ϕ}_{ℓ}^{†} \vert δ z [ δ Σ ] 〉}{{t}_{ℓ} ( {λ}_{ℓ} - {λ}_{0} )} \qquad ( 7 )$$

The expansion coefficients [symbol] are provided for the given expansion of the change in the 3D neutron flux distribution δϕ in terms of the higher modal eigenvector components. As commensurate with their property of being expansion weight coefficients, the [symbol] are dimensionless scalar values, ordered per index [symbol] .

The difference between the target power distribution p and the actual power distribution of the nuclear reactor core and/or the difference δϕ between the target 3D neutron flux distribution ϕ and the actual 3D neutron flux distribution of the nuclear reactor core can be also decomposed using a Fourier method. In other words, the expansion coefficients [symbol] can also be computed alternatively by a Fourier filtering formula, in a scenario, in which only a change (or uncertainty) δϕ in 3D neutron flux distribution would be known:

$$δ {c}_{ℓ} [ δϕ ] = \frac{〈 {ϕ}_{ℓ}^{†} \vert F δϕ 〉}{〈 {ϕ}_{ℓ}^{†} \vert F {ϕ}_{ℓ} 〉} \qquad ( 8 )$$

In this formula, F denotes the operator of the neutron production through fission.

The Fourier modal decomposition of the difference of 3D neturon flux distribution may be calculated as follows. For any given perturbation distribution δj of the interface currents j, the following formula may be used:

$$δ \underline{j} = {{\sum }^{L}}_{ℓ = 1} δ {c}_{ℓ} {\underline{j}}_{ℓ} + δ {\underline{j}}_{H F} \qquad ( 8 a )$$

The term

$${{\sum }^{L}}_{ℓ = 1} δ {c}_{ℓ} {\underline{j}}_{ℓ}$$

represents the sum of global modal effects up to the L^{th} modal shape as triggered by the local perturbations δΣ in cross-sections. The term δj_{HF} includes local, short-range effects caused by the same imposed local perturbations. From a Fourier point of view, these belong to the High-Frequency lumped term δj_{HF}. If only a given δj is available, and if one is interested in its Fourier modal decomposition in terms of the values of the modal expansion coefficients [symbol] =1, . . . , L, a well-defined formula can be derived for the computation of those expansion coefficients. This derivation can be pursued by using the conjugacy property as specified:

$$〈 {\underline{j}}_{k}^{†} \vert \hat{ℱ} {\underline{j}}_{ℓ} 〉 = {t}_{ℓ} {δ}_{ℓ k} = {t}_{ℓ} \{ \begin{matrix}1 & if k = ℓ \\ 0 & if k \neq ℓ\end{matrix} \qquad ( 8 b )$$

With [symbol] =< [symbol] |F j [symbol] > and by pre-multiplication of Equation 8a with <jₖ [symbol] |F|, which yields:

$$〈 {\underline{j}}_{k}^{†} \vert ℱ \vert δ \underline{j} 〉 = {\underbrace{{{\sum }^{L}}_{ℓ = 1} δ {c}_{ℓ} {\underbrace{〈 {\underline{j}}_{k}^{†} \vert ℱ \vert {\underline{j}}_{ℓ} 〉}}_{\text{?}}}}_{\text{?}} + {\underbrace{〈 {\underline{j}}_{k}^{†} \vert ℱ \vert {\underline{j}}_{H F} 〉}}_{= 0} \qquad ( 8 c )$$

$$\text{?} \text{indicates text missing or illegible when filed}$$

It should be known that the definition of [symbol] =< [symbol] |F [symbol] > is consistent with Eq.(4b) with [symbol] =k, and also consistent with the definition in the paragraph below Equation (6). Some of the introduced notations here are symbolic, with [symbol] denoting the modes, and here actually the specific notation is introduced that that may be used in a simple manner in an embodiment, in which the modes actually need to be defined in terms of the interface current values, hence [symbol] instead of [symbol] .

Knowing additionally that <jₖ [symbol] |F|δj_{HF}>=0 if kϵ{0, 1, 2, . . . , L}, since δj_{HF} is composed of modes jₖ with kϵ{L+1, L+2, . . . , ∞}, this leads to the following simple formula:

$$δ {c}_{k} = \frac{1}{{t}_{k}} 〈 {\underline{j}}_{k}^{†} \vert ℱ \vert δ \underline{j} 〉 \qquad ( 8 d )$$

which after the index swap k↔ [symbol] becomes:

$$δ {c}_{ℓ} = \frac{1}{{t}_{ℓ}} 〈 {\underline{j}}_{ℓ}^{†} \vert ℱ \vert δ \underline{j} 〉 \qquad ( 8 e )$$

Hence, the following detailed expression for the Fourier modal decomposition of δj is obtained:

$$δ \underline{j} = {{\sum }^{L}}_{ℓ = 1} \frac{1}{{t}_{ℓ}} 〈 {\underline{j}}_{ℓ}^{†} \vert ℱ \vert δ \underline{j} 〉 {\underline{j}}_{ℓ} + δ {\underline{j}}_{H F} \qquad ( 8 f )$$

This is useful for finding the 3D cross-section distribution perturbation δΣ that would trigger a δj with given included modal components. Equation 8e can then yield the specific target values for the modal expansion coefficients that the searched 3D cross-section distribution perturbation δΣ must enable. As it can be seen these same modal expansion coefficients also follow from MGPT in terms of the formula:

$$δ {c}_{ℓ} ≅ \frac{1}{{t}_{ℓ} ( {λ}_{ℓ} - {λ}_{0} )} 〈 {\underline{j}}_{ℓ}^{†} \vert {\hat{C}}_{1} \frac{\partial ϕ}{\partial Σ} δΣ 〉 \qquad ( 8 g )$$

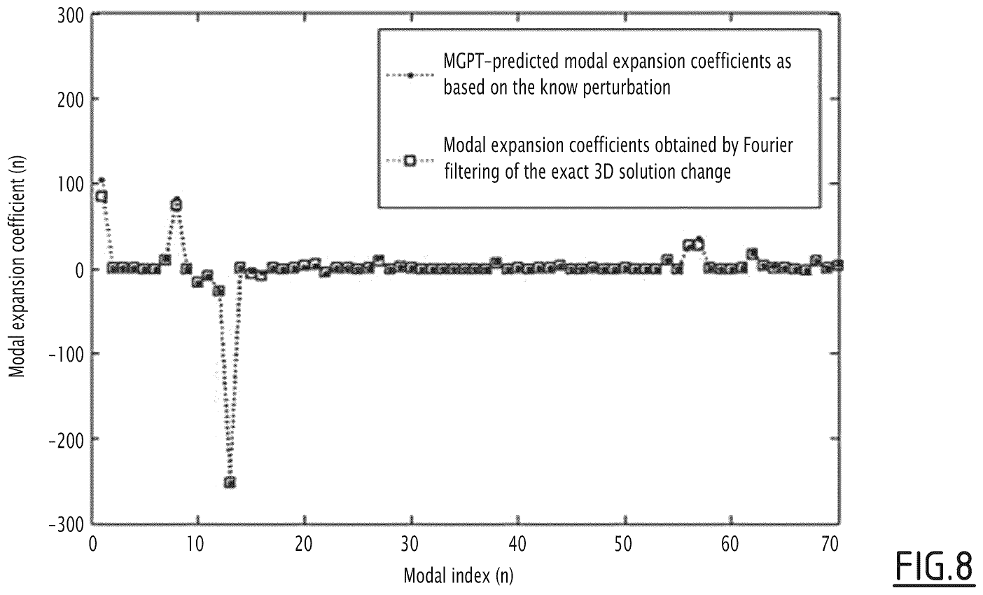

The formula 8g corresponds essentially to the formula 5a above with except the factor C₁. FIG. 8 confirms this formula. The factor C₁ relates to the propagation the nodal flux influences towards the nodal outcurrents leaving the node. From a mathematical point of view, it is clear that many different 3D cross-section distribution perturbation by can enable the same value for

$$〈 {\underline{j}}_{ℓ}^{†} \vert {\hat{C}}_{1} \frac{\partial ϕ}{\partial Σ} δΣ 〉 ,$$

and hence the same excitation of the higher mode jt. However, most of the solutions are physically meaningless.

Thus, according to the present disclosure, in step 110 the modal expansion coefficients [symbol] are determined using a Fourier modal decomposition based on the determined difference (δϕ) and applying a Modal Generalized Perturbation Theory (MGPT) to the modal expansion coefficients ( [symbol] ) for determining a 3D cross-section distribution perturbation (δΣ) causing the determined difference (δϕ).

In other words, through the connection between the modal expansion coefficients as predictable in terms of the available MGPT formulae, and the modal expansion coefficients that can be derived directly from a given target (or observed) 3D discrepancy in core-wide flux/power solution using a Fourier modal decomposition, a convenient orthogonal basis (Reduced Order Model—ROM) based on the Modal Generalized Perturbation Theory (MGPT) is used for enabling root cause analysis and for modeling the core properties (power distribution, neutron flux) in 3D depending on imposed system perturbations based on the observed change or differences in 3D neutron flux distribution δϕ. The root cause 3D cross-section distribution perturbation δΣ would also enable, in an embodiment, an optimal fulfilment (by the correspondingly adapted model), of the target power distribution.

According to embodiments, a Reduced Order Model is created by reducing the representation of (the longer wavelength part of) a change in the 3D neutron flux distribution δϕ, with dimension NT×NG×NDIM (with usually NDIM being the number of Cartesian axis in the model 2 for two dimensional computations and 3 for 3 dimensional computations, usually equal NG=3, NG being the number of (neutron energy) groups, usually NG=2, and NT being the number of nodes, which are the volume elements that together constitute the reactor core and in particular the surrounding reflector, which may be several thousands) to merely L (up to a few dozen, maximally) expansion coefficients that capture the truly relevant info, and with typically only between 5 and 10 truly relevant expansion coefficients among the L expansion coefficients. Hence, one capture the relevant information in a few expansion coefficients [symbol] as substitute for several dozens of thousands of vector values. The actually relevant information is thus reduced to to some few relevant dimensionless expansion coefficients. It is not necessary to chose the expansion coefficients 1 to 10. For example, in some embodiments radially concentric modes are relevant, and these may actually have higher indices, which is why choosing L=10 is too low, and a choice like L=80 is more likely to truly capture all the relevant modes. Thus, in some examples, out of these 80 determined modes, a subset of those, such as merely 10 (out of 80) modes, are relevant. For example, in embodiments about 100 modes are calculated, in particular with high computational efficiency.

Reducing the representation of (the longer wavelength part of) a change in the 3D neutron flux distribution δϕ, refers to the fact that the changes in the 3D solution can be analysed as being a weighted sum of triggered higher modal 3D solutions, with the most relevant being the ones with eigenvalues closest to the fundamental eigenvalues. These specific lower non-fundamental modes feature modest spatial curvatures that can be characterized as long waves, with regions of + or − sign being relatively large. The higher the mode, the higher the different spatial regions with different + or − signs for the local solution values, hence the shorter the wavelengths (and, in terms of Fourier analysis terminology, the higher the frequency). According to embodiments, the longer wavelength part that is relevant for Reduced Order Model (ROM). The wavelengths refers in particular to the propagation of the perturbation.

The ROM enables representing 3D multi-group core-wide flux solution change distributions in terms of merely few dimensionless expansion coefficients.

According to embodiments, an with respect to the equations 7 and 8, a 3D cross-section distribution perturbation δΣ responsible for an observed δϕ can be estimated by a fitting approach in order to estimate a convenient orthogonal basis of the ROM, the generalized notation for which is:

$$\begin{matrix}{min}_{δ Σ} & ‖\end{matrix} δ \vec{c} [ δ \sum ] - δ \vec{c} [ δϕ ] ‖ \qquad ( 9 )$$

In the above formula δ\vec{c} represents a vector of the expansion coefficients. The vector δ\vec{c} includes all individual expansion coefficient values [symbol] with [symbol] =1, 2, 3, 4, 5, . . . . In this formula, the minimum of the difference between the equations 7 and 8, i.e. the difference between the expansion coefficients ( [symbol] ) calculated by applying a Modal Generalized Perturbation Theory and the modal expansion coefficients ( [symbol] ) determined by using the Fourier modal decomposition, is determined on order to obtain the 3D cross-section distribution perturbation δΣ responsible for an observed difference or change in the 3D neutron flux distribution δϕ, see step 112. The minimization challenge expressed in Equation (9) is a mathematically rigorous manner of expressing the objective of determining a 3D cross-section perturbation distribution δΣ that, from the perspective of the entire collection of modal expansion coefficients, enables an overall optimum agreement between the 3D neutron flux distribution and/or power distribution solution as computed by the (adapted) model, vs the target 3D neutron flux distribution ϕ and/or power distribution p.

With a given difference δϕ of the 3D neutron flux distributions, and associated target modal expansion coefficients [symbol] [δϕ] as computable by using the Fourier equation (8), and with influentiable/adaptable perturbation effect modal expansion coefficients [symbol] [δΣ] enabled by MGPT computation, as expressed by Equation (8g), for any given by it is possible, according to an embodiment, to determine the difference in any [symbol] -th modal expansion coefficient [symbol] [δΣ] (for any mode with some index [symbol] ), versus the target value [symbol] [δϕ] as associated with any mode with some index [symbol] : [symbol] [δΣ]− [symbol] [δϕ].

For example, with an optimum choice δΣ, this difference [symbol] [δΣ]− [symbol] [δϕ] is ideally reduced to zero from the perspective of every individual modal expansion component indexed with [symbol] .

However, generally this may not always be possible to fulfil with equal numerical quality for all indices [symbol] . Due to this, according to an embodiment, the minimization challenge is formulated in terms of wanting to determine a δΣ that enables the overall best trade-off from the perspective of all different modal expansion component indexed with [symbol] (with [symbol] =1, 2, 3, 4, . . . ). This means mathematically that the sum of squared differences ( [symbol] [δΣ]− [symbol] [δϕ])², as summed over [symbol] =1, 2, 3, 4, . . . , should be minimized (and ideally reduced to zero) by optimum choice for δΣ. This sum of squared differences has the convenient property that its absolute minimum value (which is zero) is achieved only if indeed all individual, [symbol] -wise differences are reduced to zero.

The so-called L2-norm expressed in Equation (9) is the square root of the sum of squared differences ( [symbol] [δΣ]− [symbol] [δϕ])², as summed over [symbol] =1, 2, 3, 4, . . . , which has the same convenient property. This is the conventional manner of expressing such multi-dimensional fitting optimization challenges. Here, the achieved advantage is that the dimension of the fitting space is very much reduced to merely a few relevant modal expansion coefficients that should be pushed towards accurate numerical agreement.

Through the thus enabled manner of projecting a 3D fitting challenge to this heavily reduced representation space, using the additionally developed methodology (that is described on the next pages) one can set up optimum fits using this ROM. This results in a novel way of determining physically meaningful 3D cross-section distributions as plausible/probably 3D deviation root cause distribution for the observed 3D solution deviation (targeted vs computed or measured vs computed).

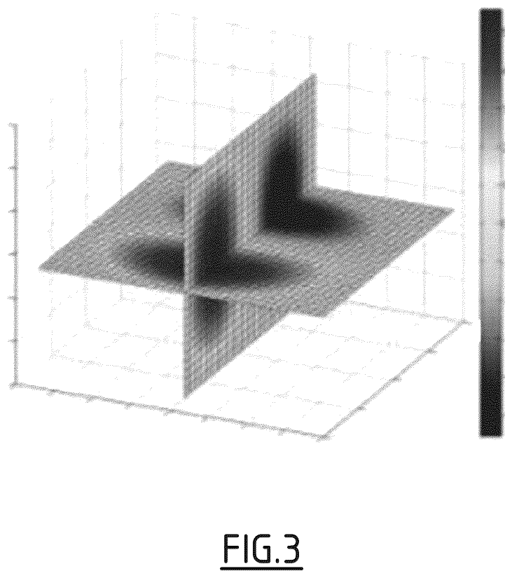

FIGS. 3 to 5 illustrate some typical spatial shapes (specifically for the first three and first radial successive modal solutions), which are the principal components in the ROM, by enabling the above-mentioned modal expansion basis.

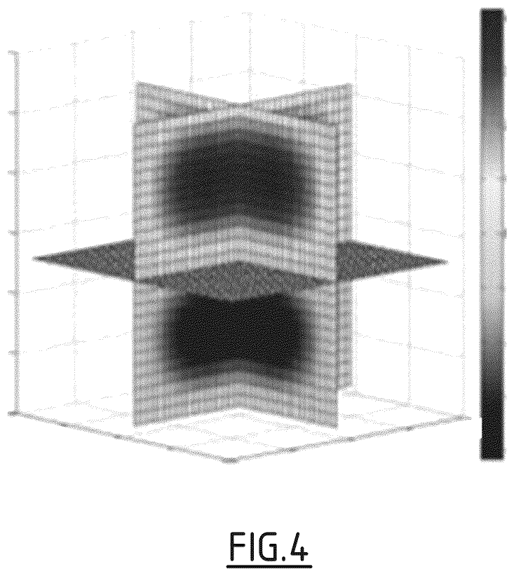

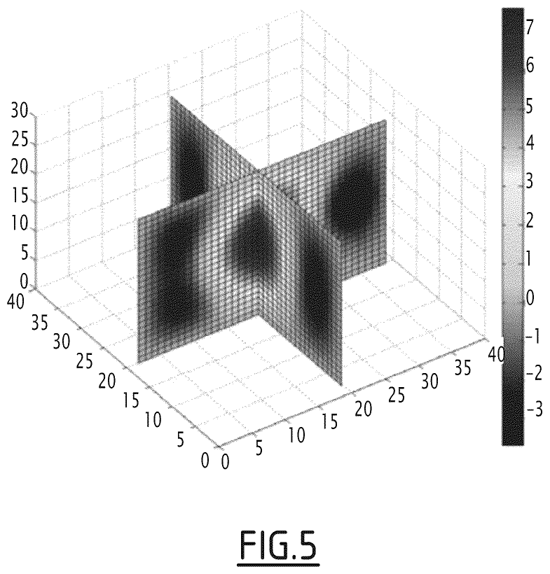

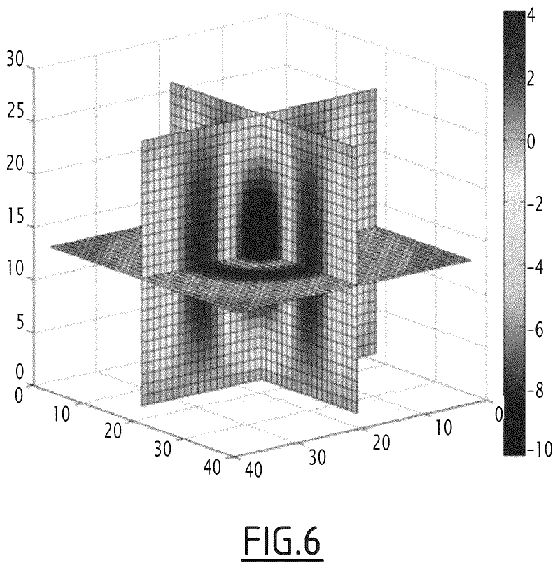

FIG. 3 shows east west azimuthal modes and FIG. 4 a top bottom mode of higher modal solutions, the east-west azimuthal modes and north-south modes (FIG. 3) are the (degenerate) 1^{st} and 2^{nd} mode, the top-bottom mode (FIG. 4) is the 3^{rd} mode, FIG. 5 the 10^{th} mode and FIG. 6 the 48^{th} mode.

In a further step, constraints 3D cross-section distribution perturbation δΣ (for example using only variations in fast diffusion coefficients as a 3D core wide distribution, only variations in fast diffusion coefficients only for the reflector nodes, only variations in the water density, only variations in a certain cross-section type (fission, absorption, or thermal fast neutrons)) can be selected in order to enable both the exact solution of the 3D power match equations and the enforcement the minimum-magnitude adaptation solution for that.

As an example, a 3D cross-section distribution perturbation by may have to be constrained in the following possible manners:
only variations in fast diffusion coefficients wished for, but as 3D core-wide distribution, as modulation lever for model adaptation→δΣ=δΣ_{tr,1} and δΣ=0 for all other neutron transport cross-section types. The modulation lever is a tuning parameter. Tr, 1 refers to transport, fast group, see for example [Duderstadt 1975], which is incorporated by reference.
only variations in fast diffusion coefficients wished for, but only in reflector nodes, as modulation lever for model adaptation→δΣ=H_{refl}δΣ_{tr,1} with δΣ=0 for all other cross-section types and the nodal selector H_{refl} having the value 1 in reflector nodes, and zero in all fuel nodes. This is relevant in exemplary approaches such as just varying reflector model properties in attempts to minimize discrepancies between model and reality in that manner;
only variations δρ by in water density wished for, as modulation lever for model adaptation through the exerted influence on the local diffusion coefficient (which corresponds to the inverse of local fast-group nodal transport cross-section) with hence by δΣ=(∂Σ/∂ρ) δρ, wherein δρ is the water density variation; and/or
only variations in a certain nodal transport cross-section type (such as Nodal transport cross-section of fission Σ_{f}, Nodal transport cross-section of absorption Σₐ,) with δz [Σ]=(δM [δΣₐ]−λ δF [δΣ_{f}]) ϕ₀ and optionally also in a certain energy group (thermal, fast) wished for, in order to enable studies on solution shape sensitivity in response to local variations/uncertainties in these specific cross-section types, or in response to global uncertainties propagated with local variations, hence basically by δΣ=(∂Σ/∂x) δx is obtained.

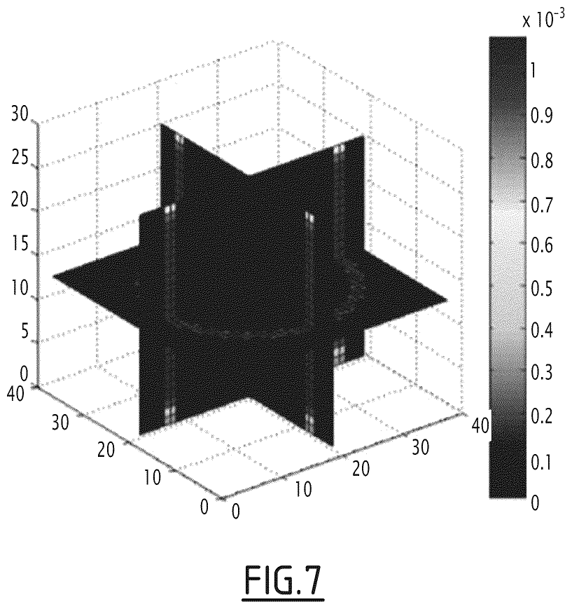

FIG. 7 shows an example of a given known 3D cross-section distribution perturbation (or uncertainty) δΣ, which is a ring of 1% elevations in thermal absorption cross-sections. This means that the neutron absorption is increased of about 1% in this area. In other words FIG. 7, shows a simulated root cause of for a difference or change in the 3D neutron flux distribution δϕ.

For this known 3D cross-section distribution perturbation by and its exact effect on the change of the 3D neutron flux distribution δϕ, the FIG. 8 illustrates the agreement between the expansion coefficients of the MGPT (based on the cause 3D cross-section distribution perturbation δΣ) versus the Fourier (based on the effect δϕ). Both index n used in FIG. 8 corresponds to the index f. Both expansion coefficients [symbol] are associated with the 3D effects of perturbations, hence with perturbation effects δϕ as due to perturbations δΣ. The expansion coefficient [symbol] can be directly determined by by the MGPT formula explained here-above with respect to equation 7. The Fourier values follow from application of the Fourier filtering formula as explained above with respect to the equations 8, 8a to 8e.

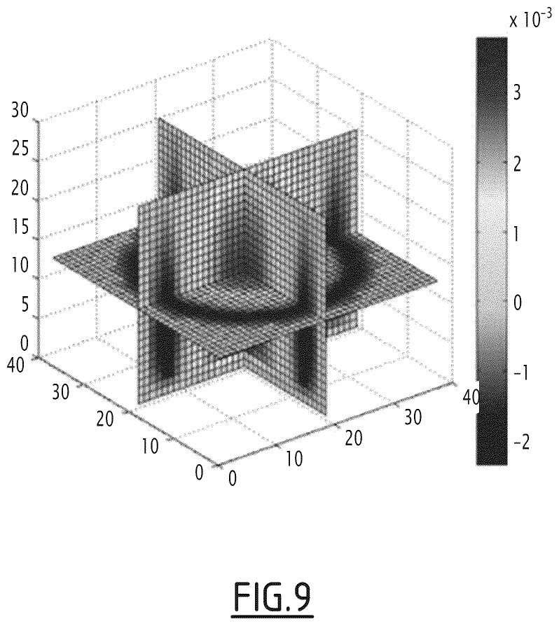

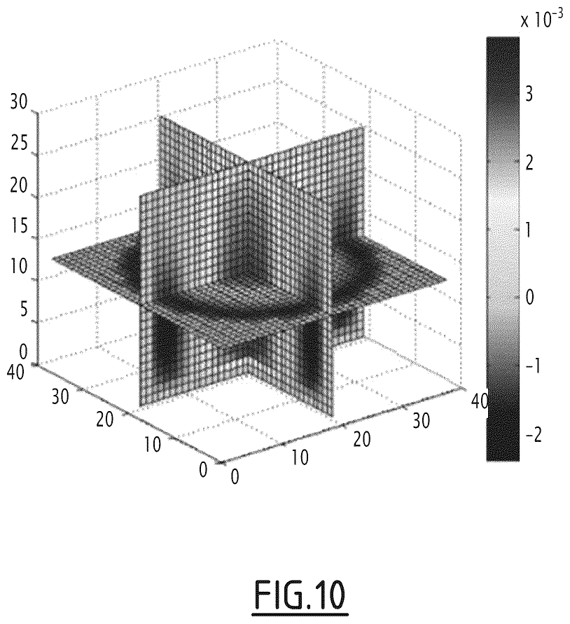

Furthermore, a 3D comparison shown in FIG. 9 (exact calculation) and FIG. 10 (using MGPT) show the very good agreement between the MGPT-predicted change of the 3D neutron flux distribution δϕ (as based on the MGPT expansion formula) in FIG. 10 and the real change of the 3D neutron flux distribution δϕ (determined per computationally expensive, exact iterative determination of the real solution change) in FIG. 9.

In other words, FIGS. 8 and 9 show that MGPT can be used as a valid method for the calculation.

In the following, more details are described, which enable the determination of the 3D cross-section distribution perturbation δZ based on the equation (9).

The mathematical basis for the procedure is matching Eq.(8e) with Eq.(8g). Formulated alternatively, the modal expansion coefficients [symbol] as determined by the MGPT formula (as a function of the root cause) must be matched with the modal expansion coefficients that (as a function of the 3D target (or observed) solution discrepancy distribution) follow from using Eq.(8g). In embodiments, the associated higher modal solutions for the adjoint/forward interface currents [symbol] and [symbol] in the actual MGPT and Fourier expressions are used. An adjoint matrix corresponds to a transposed conjugated matrix and is marked with “↑”. The modal eigenvectors, used as expansion functions, are meant can be solved (iteratively), through use of the multi-modal deflation process as described in R. van Geemert, MODAL ANALYSIS OF 3D FULL-CORE INHOMOGENEOUS ADJOINT NODAL EQUATIONS AND ASSOCIATED ITERATIVE SOLUTION PROCESSES, Proceedings M&C 2019, Portland OR, USA (2019), which is incorporated by reference herein.

In some embodiments, based on the above determined constraints a transfer operator \hat{T}ₓ is introduced that symbolizes how a feasible 3D adaptation distribution δx of tuning parameters can influence the local nodal cross-section distribution Σ. The transfer operator T̅ₓ is used for enabling modal match optimizations with constraints, such as when users will only want to vary reflector properties, only vary moderator densities, and/or for making the computed power shape match the target power shape as much as possible. However, the varied quantities are then constrained spatially, and/or they are not cross-sections and they influence the cross-sections through indirect mechanisms. The Transfer operator is used for modeling the effect of variations in the tuning quantities on the 3D cross section distribution Σ, which may be used as input for MGPT calculations.

As indicated above with respect to the constraints, δx can be constrained to certain cross-section types, and to certain spatial subregions such as the radial and/or axial reflectors, or to certain groups of assemblies or control rods.

For example, the transfer operator \hat{T}ₓ could be defined as follows in some embodiments in case there would be an interest in assessing the power shape effect of uncertainties in Gd content in only the resh fuel assemblies:

$${\hat{T}}_{x} = {\hat{H}}_{x} \frac{\partial \underline{\sum }}{\partial \underline{x}} \qquad ( 9 a )$$

Here, the Operator Ĥₓ indicates a possible subregion selection operator whose value is 1 for the selected region, for example reflectors, or specific fuel assemblies and zero otherwise, and the operator and the operator δΣ/δx denotes the local propagation of variations in x (subject to Ĥₓ=1 locally).

As another example, indicated above with respect to the constraints, in case of only variations δ∂ in the water density wished for, we would get δx=δ∂ and:

$${\hat{T}}_{x} = {\hat{T}}_{ρ} = {\hat{H}}_{ρ} \frac{\partial \underline{\sum }}{\partial \underline{ρ}} \qquad ( 9 b )$$

The transfer operator \hat{T}ₓ can be defined such that the system of equations is generalized for handling specifically constrained inversions. For Equation 5a this means that the operation (∂j/∂Σ)δΣ is replaced by the actually feasible operation (∂j/∂Σ)\hat{T}ₓδx, Thus the expansion coefficient according to the MGPT can be noted as follows:

$$δ {c}_{{ℓ}_{}} [ δ \underline{\sum } ] ≅ {α}_{ℓ} 〈 {{\hat{T}}_{x}^{†} ( \partial \underline{j} / \partial \underline{\sum } )}^{†} {\underline{j}}_{ℓ}^{†} \vert δ \underline{x} 〉 = 〈 \frac{\partial {c}_{ℓ}}{\partial \underline{x}} \vert δ \underline{x} 〉 \qquad ( 9 c )$$

With the following definitions:

$$\frac{\partial {c}_{{ℓ}_{}}}{\partial \underline{x}} = {{\hat{T}}_{x}^{†} ( \partial \underline{j} / \partial \underline{\sum } )}^{†} {\underline{j}}_{ℓ}^{†} \qquad ( 9 d )$$

$$and$$

$${α}_{ℓ} = \frac{1}{{t}_{ℓ} ( {λ}_{0} - {λ}_{ℓ} )} . \qquad ( 9 e )$$

δx denotes the general distribution of tuning parameters, for example moderator densities in fuel, or moderator densities in the reflector (which is spatially constrained) that act upon the nodal cross sections. The 3D cross-section distribution perturbation δΣ by being a (usually constrained) function of δx. For physically feasible adaptations δx, a role is played by the (adjoint of the) local derivatives (δj/∂Σ)⁺, the (adjoint of the) transfer operator \hat{T}ₓ⁺, which is explained here-above, the axial summation operator Û⁺, which effects a sum of captured axis-dependent quantities. summed over all three Cartesian axes x, y, z, and the adjoint interface currents: [symbol] for setting up node- and energy-group-compressed modal sensitivity vectors [symbol] defined as:

$${\underline{θ}}_{xℓ}^{†} = {\hat{U}}^{†} {{\hat{T}}_{x}^{†} ( \partial \underline{j} / \partial \underline{\sum } )}^{†} {\underline{{j}_{ℓ}}}^{†} \qquad ( 10 )$$

Using these modal sensitivity vectors [symbol] , the MGPT-predicted expansion coefficients [symbol] used in the equations (6) and (7) in dependence on the adaptation δx follow from:

$$δ {c}_{ℓ}^{{( MGPT )}^{}} [ δ \underline{x} ] = {\sum }_{ℓ = 1}^{L} {α}_{ℓ} 〈 {\underline{θ}}_{x ℓ}^{†} \vert δ \underline{x} 〉 \underline{{j}_{ℓ}} \qquad ( 11 )$$

with the [symbol] defined as: [symbol] =1/( [symbol] ( [symbol] −λ₀). δx is a vector length up to the number of nodes in the core, for example 10⁴ to 10⁵. The modal match equations then boil down to:

$$〈 {\underline{θ}}_{x ℓ}^{†} \vert δ \underline{x} 〉 = {α}_{ℓ} {δc}_{ℓ}^{( t a r g e t )} \qquad ( 12 )$$

with the [symbol] denoting the target values for the expansion coefficients, as associated with a target solution deviation between the measured value and the calculated value in step 108.

With a total of L modal expansion components considered in the ROM setup, this leads to the following L equations to be fulfilled by the 3D adaptation distribution δx:

$$( \begin{matrix}〈 {\underline{θ}}_{x , 1}^{†} \vert \\ 〈 {\underline{θ}}_{x , 2}^{†} \vert \\ \cdot \\ \cdot \\ \cdot \\ 〈 {\underline{θ}}_{x , L - 1}^{†} \vert \\ 〈 {\underline{θ}}_{x , L}^{†} \vert\end{matrix} ) \vert δ \underline{x} 〉 = ( \begin{matrix}δ {\tilde{c}}_{1}^{( t a r g e t )} \\ δ {\tilde{c}}_{2}^{( t a r g e t )} \\ \cdot \\ \cdot \\ \cdot \\ δ {\tilde{c}}_{L - 1}^{( t a r g e t )} \\ δ {\tilde{c}}_{L}^{( t a r g e t )}\end{matrix} ) \qquad ( 13 )$$

Typically, L is some number between 10 and 100, whereas the 3D adaptation distribution δx is typically defined for some few (tens of) thousands of nodes. Due to this, there are actually many different 3D adaptation distributions δx that fulfil these modal match equations. The number of modes L is selected dependent on the requirements and the available time and computing resourcing. In particular the number L is selected such that all modes of practical relevance are included. Using 100 modes (L=100) is usually always enough.

However, there is a possibility of enforcing the smallest-possible 3D adaptation distribution δx as solution, which has physical meaning and thereby is very desirable.

In some embodiments, the overall discrepancy source distribution can be assumed to be related to model imperfections, such as use of diffusion instead of transport, imperfect reflector models, etc.

Hence, the discrepancy root cause distribution will typically show peaks in areas such as fuel/reflector interface and within-core areas featuring large transitions in material properties. These give rise typically to modal shapes for the deviation in 3D power distribution. Oddly, some known heuristic adaptation procedures define a modal shape for the adaptation in the model, instead of striving to find a physically plausible adaptation that might actually point out the imperfections in the model. These heuristic adaptations also typically imply a larger departure from the uncorrected model, also in inner-core areas in which the model approximations are actually well-justified.

According to the present disclosure, a 3D deviational shape is translated towards a minimum-norm, plausible (root cause) adaptation distribution δx. As already stated, the equation (9) is the property that must be reached in any case, which however has mathematically several different solutions of which most have no physical meaning or are uninteresting.

The present disclosure includes the derivation of application-tailored sensitivity expressions (based on MGPT as stated above with respect to Equations (5a), (8) constrained to Equation (9c) which can be tailored to applications using Equations (9) to (13), which describe how a choice for δx, that imposes constraints on the feasible δΣ by can nonetheless be handled appropriately by the present disclosure), modal sensitivity vectors [symbol] , and the derivation/formation of an orthonormal expansion basis with which the minimal-L2-norm solution can be spanned and solved (i.e. lower-diagonal system eventually). L2 refers to the Hilbert space, spanned by the orthogonalized sensitivity expansion vectors.

According to embodiments, not only does this enable to capture with “target” solution deviation with full modal detail (i.e. including axial+azimuthal components); additionally, due to the implicitly achieved property of the minimized L2-norm, these adaptation distributions δx also focus on parts of the system where a root cause concentration is most plausible due to being most influential in spite of being small, combined with the (Occam's razor-like or Artificial Intelligence-like) assumption that the most plausible adaptation distribution δx is not rarely the one with the highest inherent influence propagation potential (i.e. the “usual suspects”, such as the fuel-reflector interface which is hard to model highly accurately using nodal diffusion instead of fine-grid transport). The true root cause for the otherwise imperfect match cannot plausibly be distributed in this particular manner, it is way more likely to be connected to the specific sub-regions for which nodal results can plausibly be assumed to be inaccurate locally, with a globally propagated effect (in terms of triggered higher modes that, among others, add up to a global radial outer-inner trend) being the result of that. These may be reflectors (i.e. fuel/reflector-interface), nodes with exotic dimensions or control rods. However, for many of the inner core regions, the nodal equations should actually be capable of enabling good local modeling accuracy. Hence, actually if one imposes some adaptation, then for this to adhere plausibly to physically defendable assumptions concerning where the model must actually be imperfect and hence in need of (local) correction measures, this adaptation should preferably be consistent with that. It is exactly this kind of (numerically smaller) 3D adaptation distribution adaptation distribution δx that the new approach enables to determine, through the inversion procedure in particular comprising the Occam's razor principle through guaranteed minimization of the adaptation's L2-norm. The distinguished property is that, from a numerical point of view, a minimal overall local departure from the uncorrected state is enabled, because the adaptation change is minimal (i.e. often close to zero in most nodes), and not rarely clearly non-zero only in the parts where the root cause origin is plausible: fuel/reflector nodes, nodes with extremal aspect ratios, and by the way with the needed axial variations (which come automatically from the procedure).

Hence, the enabled 3D adaptation distributions δx offer the property of not only enabling the exact target global power shape deviation, they also provides info on which minimum-necessary distribution of root causes would have caused the globally observed discrepancy, it gives specific info on:
where the core model is rather likely to be imperfect
which specific parts of the core model (such as reflector model) would have to be improved in order to reduce the need for adaptation (i.e. to reduce the distance between the nodal model's results vs measurements or vs results of higher-fidelity models),
which local accuracy upgrades would be the most influential (i.e. maximum adaptation effect vs minimum local model improvement) for improving the global solution, etc.

For achieving this, a Gramm-Schmidt process may be used to enable a suitable mathematical expansion basis, in particular an orthogonalized expansion basis, ϑ for determining the smallest-norm solution δx of Equation (12) for the modal sensitivity [symbol] , with a lower-diagonal expansion coefficient matrix B, such that

$${\underline{θ}}_{x ℓ}^{†} = {\sum }_{k = 1}^{ℓ} {B}_{xℓk} {\underline{ϑ}}_{xk}^{†} ∀ ℓ = 1 , … , L \qquad ( 14 )$$

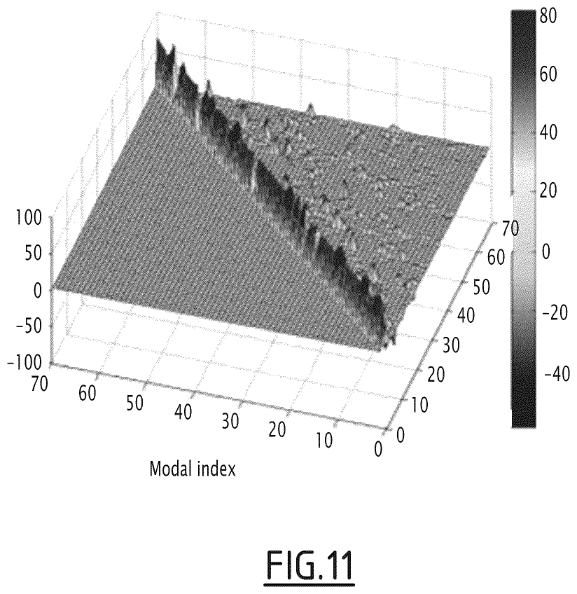

FIG. 11 illustrates a typical lower-diagonal structure of B. The matrix B allows a direct, non-iterative inversion of B, wherein each axis represents the modal indices.

The specific adaptation distribution δx that features the property of being of minimum overall magnitude (in terms of a minimized value for the quadratic norm<δx|δx>), is now given by the following span in terms of the orthogonalized expansion basis ϑ:

$$δ {\underline{x}}_{s p a n} = {\sum }_{ℓ = 1}^{L} {δβ}_{xℓ} {\underline{ϑ}}_{xℓ}^{†} \qquad ( 15 )$$

with the coefficients [symbol] given in terms of the vector:

$$δ \underline{{β}_{x}} = {\hat{B}}_{x}^{- 1} δ {\underline{\tilde{c}}}^{( target )} \qquad ( 16 )$$

The coefficients [symbol] acquire a meaning once the precise manner in which they are solved is decided and applied, otherwise they are dimensionless. Their meaning is defined in terms of being the expansion coefficients associated with the minimum-necessary adaptation. With the quadratic norm

$$▯ δ {\underline{x}}_{s p a n} ▯ = 〈 δ {\underline{x}}_{s p a n} \vert δ {\underline{x}}_{s p a n} 〉 \qquad ( 17 )$$

having the specific property that it is the lowest possibly overall 3D adaptation magnitude, if indeed the 3D adaptation distribution δx is constructed in this specific manner. The squares signify the use of the quadratic norm. The term “span” comes from the linear algebra nomenclature; due to the expansion functions, being the [symbol] as used in Equations (14), (15), typically featuring some well-defined mutual orthogonality property, the final result can be spanned as a vector-like quantity, in terms of the different available directions with different span weight factors per direction.

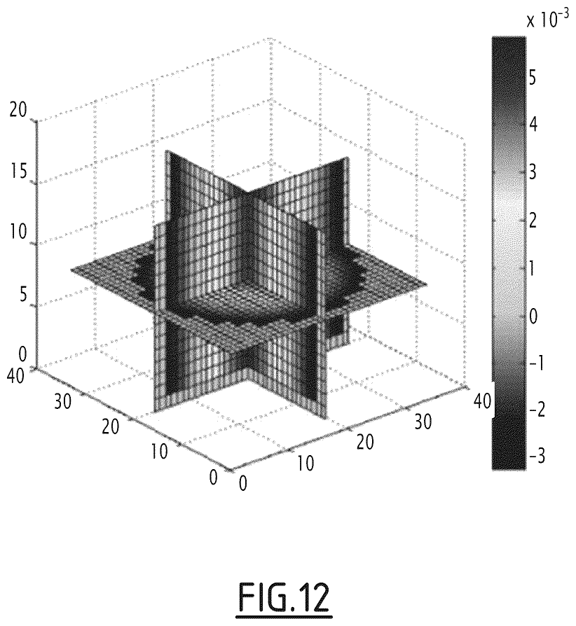

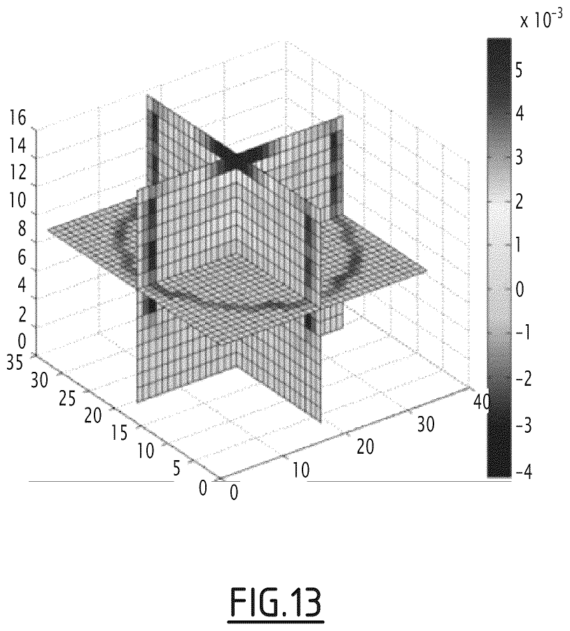

This enables the automated computation of physically meaningful 3D adaptation distributions δx. FIG. 12 shows a calculation using a heuristic model and FIG. 13 shows a calculation using the method according to the present disclosure. In comparison with heuristic adaptation approaches, these enable better 3D core power shape matches, with a lower operator-level difference between the adapted and the unadapted model. The 3D core power shape is essentially determined by how the different fuel assemblies (with varying degrees of fuel burnup) are loaded/ordered in the core, in other words the power of the nuclear reactor 7 at different locations in the nuclear core.

The 3D nuclear power shape includes detailed information on the power level (as correlated to the fission rate combined with the local thermal flux value) in the different spatial and/or nodal positions in the core, with hence radial and axial dependence.

Due to this, different fuel assemblies, with different burnup (and hence different local fission core-sections) will feature local assembly powers in partial dependence on where in the core they are located (due to the spatial dependence of the thermal flux values in the core). Simultaneously, differences in choices about where specific fuel assemblies are put in the core co-influence the 3D system-wide distribution of flux/power (this is the loading patter optimization challenge: the optimum ordering of differently burnt fuel assemblies, combined with the 3D power distribution co-determined by these positionings according to the given loading scheme, determine if the overall nuclear fuel depletion (for multiple successive cycles) is fulfilling optimum fuel usage economy, with also full satisfaction of all safety constraints, or not. Generally, it is the challenge of core loading pattern design optimization to achieve optimum core behaviour, from both the fuel economy and the core safety perspective.

Additionally, the 3D core power shape provides valuable information about the actual 3D distribution of imperfections in the unadapted model, which can be acted upon in the context of pursuing application-targeted model fidelity improvements in large-scale-applied nodal reactor codes.

As it can be seen from FIGS. 12 and 13:

$$▯ δ {\underline{x}}_{s p a n} ▯ << δ {\underline{x}}_{heuristic} ▯ \qquad ( 18 )$$

According to the present disclosure an automated determination of an optimal 3D core adaptation for target 3D power distribution is enabled, that is numerically minimized (i.e. minimal integral quadratic norm), enables the target 3D power shape very comprehensively (in terms of exactly matching the main modal longer wavelength shape components), has a true physical meaning (such as auto-included local nodal transport corrections), enables nodal model quality boot-up while keeping the computational efficiency, has the advantages of nodal models, provides plausible insight about deviation root causes, and/or thereby also helps in complex 3D root cause analysis (such as for large pressurized water reactors (PWRs).

In particular, the 3D adaptation distribution δx of the present disclosure could be used to:
determine nuclear core loading change distributions that would enable the target system property, wherein the loading relates to the loading of the fuel assemblies;
overall improved calculation of an 3D adaptation distribution based on a target neutron flux distribution, in other words, the discrepancy between the calculation model used and the reality is reduced;
automated quality boot-up of nodal models through implicit automated nodal transport cross-section correction of neutrons;
refrain from “manual” tuning based on heuristic approaches that offer far too few degrees of adaptation freedom for enabling best-achievable agreement;
determine physically meaningful model adaptations that enable an optimum 3D power shape match, wherein the adaptation depends on the degrees of freedom, for example the whole-core fast group neutron transport cross-section distribution;
core loading pattern optimization;
enable direct guidance in 3D power flattening, in other words the reduction of power differences within the nuclear reactor 7, (helpful in core design optimization), by translating the difference between a (flat) target 3D core power shape towards a directly inverted target distribution of material properties that can be optimally met by permutations of fuel assemblies and optimization of fuel assembly designs. This is for example performed by by projecting the entire highly-dimensional optimization problem of consistent 3D power flattening to the small reduced-order-model (ROM) space that simply defines a few target values for modal expansion methods to be matched. This simplifies the computational challenge, and the objective function becomes quasi-analytical. Hence, the effects of permutations on the power shape could, in a surrogate manner, be assessed simply in terms the effects on the modal expansion coefficients, for determining whether those permutations would enable a flatter power shape; and/or
acquire rather direct information about which parts of the unadapted model would need to be improved for achieving an overall accuracy fidelity upgrade (in terms of the aspired optimum agreement with the target as provided by higher-fidelity models or by real-system-measurements)

The method according to the present disclosure includes for example the following principle: the automated minimization of the adaptation's overall magnitude in terms of its so-called quadratic norm. For the modal formulation of the 3D power shape adaptation optimization challenge, there are actually infinitely many solutions. These are the infinitely many 3D adaptation distributions δx that would enable exactly the same multi-modal match. However, the basic assumption is that, among these infinitely many solutions, the one with the smallest overall quadratic norm magnitude must be the one with the highest physical plausibility, or at least must be the one with the highest desirability.

Indeed, the 3D adaptation distributions δx, as generated according to the present disclosure, can actually be interpreted as automated corrections for inherent model deficiencies as due to the coarse (but computationally very attractive) few-group nodal diffusion approach, with uncertainties in cross-sections. This is then possibly the closest one can get to the ideal-yet-unavailable high-fidelity core model (whose unadapted solution would already enable the perfect 3D match with reality), while yet keeping the computational efficiency and conceptual simplicity of a nodal reactor core model.

In the following, the variables of the formulas are explained:
B lower-diagonal expansion coefficient matrix
[symbol] coefficient
c_{B} concentration of solution boron in the reactor core
[symbol] expansion coefficient
\hat{F}, F neutron production through fission
δ\hat{F} of perturbation of neutron production through fission
H_{refl} nodal selector
j [symbol] ₜ interface current
k_{eff} effective multiplication factor of the reactor core
k [symbol] , k₀, k₁, k₂ higher modal eigenvalues
κ amount of energy released per fission
λ neutronic eigenvalue
[symbol] =1/ [symbol] lambda eigenvalues associated with the higher model solutions ϕ [symbol]
[symbol] index for successive ranking of the modes and their eigenvalues
L Highest mode used for the calculation
\hat{M} combined operator for neutron absorption, leakage and scattering,
δ\hat{M} perturbation of neutron absorption, leakage and scattering
\vec{p} 3D power distribution or power distribution
ϕ 3D neutron flux distribution,
[symbol] 3D neutron flux distribution at a higher modal solution
δϕ Difference or change in the 3D neutron flux distribution
δρ water density
\vec{Σ} 3D cross-section distribution
\vec{Σ}_{f} Nodal transport cross-section of fission
\vec{E}ₐ Nodal transport cross-section of absorption
δΣ 3D cross-section distribution perturbation (or uncertainty)
t [symbol] scalar factor,
\hat{T}ₓ transfer operator
[symbol] modal sensitivity vector
ϑ̅ orthogonalized expansion basis
Û axial summation operator
V Nodal volume vector
δx adaptation distribution of tuning parameters
δz an intermediate MGPT quantity defined on page 12, given by δz [Σ]=(δM [δΣ]−λ δF [δΣ]) ϕ

1-15. (canceled)

16: A computer implemented method for simulating an operation of a reactor core comprising:
determining an initial state of the reactor core, the reactor core comprising a plurality of fuel assemblies, wherein the core is partitioned in cubes to constitute nodes of a grid;
calculating, based on the initial state, a nodal target power distribution and/or the target 3D neutron flux distribution;
obtaining an actual power distribution and/or the actual 3D neutron flux distribution of the nuclear reactor core;
determining a difference between the target power distribution and the actual power distribution of the nuclear reactor core and/or determining a difference between the target 3D neutron flux distribution and the actual 3D neutron flux distribution of the nuclear reactor core;
determining modal expansion coefficients using a Fourier modal decomposition based on the determined difference and applying a Modal Generalized Perturbation Theory, MGPT, to the modal expansion coefficients for determining a 3D cross-section distribution perturbation causing the determined difference; and
determining a 3D adaptation distribution for the determined difference based on the determined 3D cross-section distribution perturbation.

17: The method according to claim 16, wherein the initial state of the reactor core includes as parameters the core grid, the core size, the nuclide densities, the material densities, the nuclear fuel loading structure and/or the nodal cross-sections.

18: The method according to claim 16, wherein constraints for a 3D cross-section perturbation distribution are defined in order to determine the 3D adaptation distribution for the perturbation.

19: The method according to claim 18, wherein the constraints are selected from a group comprising:
constraining the 3D cross-section distribution perturbation only in variations in fast diffusion coefficients wished for;
constraining only variation in water density wished for; and
constraining variations in a certain nodal transport cross-section type.

20: The method according to claim 16, wherein the target power distribution and/or the target 3D neutron flux distribution is determined using a Nodal Expansion Method.

21: The method according to claim 20, wherein, for calculating the target power distribution and/or the target 3D neutron flux distribution the following equation is solved:
$$\hat{M} [ {c}_{B} , ϕ ] ϕ = \frac{1}{{k}_{eff}} \hat{F} ϕ ,$$
wherein \hat{M} represents the combined operator for neutron absorption, leakage and scattering, \hat{F} represents neutron production through fission, Φ represents the 3D neutron flux distribution, cB represents the concentration of solution boron in the reactor core, and keff represents the effective multiplication factor of the reactor core.

22: The method according to claim 16, wherein the actual power distribution and/or the actual 3D neutron flux distribution of the nuclear reactor core is obtained through measurements and/or a reference computation.

23: The method according to claim 16, wherein determining a 3D cross-section distribution perturbation causing the determined difference includes reducing the number of expansion coefficients.

24: The method according to claim 16, wherein determining a 3D cross-section distribution perturbation causing the determined difference includes using a fitting approach by using determining the minimum of the difference between expansion coefficients calculated by applying a Modal Generalized Perturbation Theory and the modal expansion coefficients determined using by using the Fourier modal decomposition.

25: The method according to claim 16, wherein the method further comprises:
adapting the parameters of the initial state of the reactor core, based on the 3D adaptation distribution; and
recalculating, based on the adapted initial state, for each node a target power distribution and/or the target 3D neutron flux distribution.

26: The method according to claim 25, wherein the parameters include the core grid, the core size, the nuclide densities, the material densities and/or the nuclear fuel loading structure and/or nodal cross-sections.

27: A computer implemented method for optimizing a reactor core,
wherein the reactor core is simulated according to claim 16,
wherein the method further includes the following step:
permuting fuel assemblies based on the 3D adaptation distribution;
optimizing the core loading pattern based on the 3D adaptation distribution; and/or
optimizing the fuel assembly design based on the 3D adaptation distribution.

28: A computer program product comprising instructions, which, when the program is executed by a computer, cause the computer to carry out the computer implemented method of claim 16.

29: A data carrier signal carrying the computer program product of claim 28.

30: A computer-readable storage medium comprising instructions which, when executed by a computer, cause the computer to carry out the computer implemented method of claim 16.

31: A data processing system comprising means for carrying out the computer implemented method of claim 16.
